(19) United States
(12) Patent Application Publication
(10) Pub. No.: US 2016/0286947 A1
(43) Pub. Date: Oct. 6, 2016

(54) Eyeglasses Holder on Pants

(71) Applicant: Michael Shotey, Scottsdale, AZ (US)

(72) Inventor: Michael Shotey, Scottsdale, AZ (US)

(21) Appl. No.: 14/801,342

(22) Filed: Jul. 16, 2015

Related U.S. Application Data
(63) Continuation-in-part of application No. 14/706,342, filed on May 7, 2015.
(60) Provisional application No. 62/143,429, filed on Apr. 6, 2015.

(51) Int. Cl. A45F 5/02; G02C 3/00; D05B 1/00; A41D 1/06

(52) U.S. Cl. CPC A45F 5/02; A41D 1/06; G02C 3/00; D05B 1/00; A45F 2005/023

(57) ABSTRACT

An eyeglasses holder on pants is contemplated. The eyeglasses holder may include a strip of material and a gap formed between the strip of material and the pants. The strip of material is coupled to a front portion and a top portion of the pants and includes two opposing ends coupled to the front portion of the pants. The strip of material is positioned within approximately 6″ of a top edge of the pants and forward of a side seam of the pants at a distance that is within approximately 35% of the width of the pants but not closer than approximately 5% of the width of the pants. The gap is formed between the two opposing ends of the strip of the material and between the strip of material and the front portion of the jeans. The gap includes a width of between approximately ½″ and approximately 1″.

### CROSS REFERENCE TO RELATED APPLICATIONS

This document claims the benefit of the filing date of U.S. Provisional Patent Application 62/143,429 entitled “Eyeglasses Holder on Pants” to Shotey, which was filed on Apr. 6, 2015, the contents of which are hereby incorporated by reference.

This application is also a continuation-in-part application of the earlier U.S. Utility patent application to Shotey et al. entitled “Eyeglasses Holder on Pants,” application Ser. No. 14/706,342, filed May 7, 2015, now pending, the disclosure of which is hereby incorporated herein by reference.

### BACKGROUND

1. Technical Field

Aspects of this document relate generally to eyeglass holders on pants.

2. Background Art

Eyeglass and sunglass wearers are often perplexed as to where to place their glasses when they don't want them on their faces. Some place them up on the top of their head, others tuck them into their shirt or into a shirt pocket, some others shove them into a pants pocket or, if they are carrying one, into a purse. Conventional pants are not designed for safely holding eyeglasses. Glasses placed on a wearer's head, shirt pocket or tucked into a shirt often fall off or slip out when the wearer moves around or leans over. Glasses wearers also do not always carry a purse and don't want to damage the glasses by placing them in a pants pocket.

### SUMMARY

According to one aspect, an eyeglasses holder on pants comprises a strip of material coupled to and encircling a belt loop of the pants; and a gap formed between the strip of material and a front portion of the belt loop, the gap extending continuously from a top edge of the strip of material to a bottom edge of the strip of material and comprising a width of between approximately ¼″ and approximately ¾″.

Various implementations and embodiments may comprise one or more of the following. The strip of material may be slidably coupled to the belt loop. The strip of material may be positionally coupled to lower half of the belt loop. The strip of material may be positionally coupled to a rear portion of the belt loop. The strip of material may be positionally coupled to the rear portion of the belt loop with stitching. The belt loop may comprise one of a front belt loop and a side belt loop on the pants. A height of the gap may be approximately ⅛″.

According to another aspect, an eyeglasses holder on pants comprises a strip of material and a gap. The strip of material is coupled to a belt loop of the pants, and comprises a top edge and a bottom edge opposite the top edge. The belt loop comprises a front portion, a rear portion opposite the front portion and facing the pants, and two opposing side edges. The gap is formed between the strip of material and the front portion of the belt loop. The gap extends continuously from the top edge of the strip of material to the bottom edge of the strip of material and continuously between the two opposing side edges of the strip of material.

Various implementations and embodiments may comprise one or more of the following. The strip of material may encircle the belt loop. The strip of material may be slidably coupled to the belt loop. The strip of material may be positionally coupled to lower half of the belt loop. The strip of material may be positionally coupled to a rear portion of the belt loop with one of adhesive and stitching. The belt loop may comprise one of a front belt loop and a side belt loop on the pants.

According to another aspect, a method of forming an eyeglasses holder on pants comprises preparing a strip of material for coupling to the pants, coupling the strip of material to the pants, and forming a gap between an unattached portion of the strip of material and the pants, the gap extending continuously from a top edge of the strip of material to a bottom edge of the strip of material.

Various implementations and embodiments may comprise one or more of the following. Coupling the strip of material to the pants may comprise coupling the strip of material to one of a front belt loop and a side belt loop of the pants, and forming the gap between the unattached portion of the strip of material and the pants may comprise forming the gap between the unattached portion of the strip of material and a front portion of the one of the front belt loop and the side belt loop of the pants. Coupling the strip of material to one of the front belt loop and the side belt loop may comprise slidably coupling the strip of material to one of the front belt loop and the side belt loop. Coupling the strip of material to one of the front belt loop and the side belt loop may comprise positionally coupling the strip of material to one of the front belt loop and the side belt loop with one of stitching and adhesive. Coupling the strip of material to the pants may comprise coupling two opposing ends of the strip of material within 6″ of a top edge of the pants such that the unattached portion of the strip of material is between the two opposing ends coupled to the top portion of the pants. Forming the gap between the unattached portion of the strip of material and the pants may comprise forming a gap between the unattached portion of the strip of material and the pants that is between approximately ½″ and approximately 1″ in width. Coupling the two opposing ends of the strip of material within 6″ of the top edge of the pants may comprise coupling the strip of material between the top edge of the pants and a scoop pocket edge of the pants.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The invention will hereinafter be described in conjunction with the appended drawings, where like designations denote like elements, and:

FIG. 1 is a front view of pants;

FIG. 2 is an enlarged front view of a portion of the pants of FIG. 1;

FIG. 3 is an enlarged perspective view of the portion of the pants of FIG. 1;

FIG. 4 is an enlarged top view of the portion of the pants of FIG. 1;

FIG. 5 is an enlarged bottom view of the portion of the pants of FIG. 1;

FIG. 6 is an enlarged left side view of the portion of the pants of FIG. 1;

FIG. 7 is an enlarged right side view of the portion of the pants of FIG. 1;

FIG. 8 is an enlarged perspective view of the portion of pants with sunglasses hanging from an eyeglasses holder; and

FIG. 9 is an enlarged perspective view of a portion of pants including a second embodiment of an eyeglasses holder coupled to a belt loop.

### DESCRIPTION

This disclosure, its aspects and implementations, are not limited to the specific components or assembly procedures disclosed herein. Many additional components and assembly procedures known in the art consistent with the intended eyeglasses holder on pants and/or assembly procedures for an eyeglasses holder on pants will become apparent for use with implementations of eyeglasses holders on pants this disclosure. Accordingly, for example, although particular strips and pants is disclosed, such strips and pants and implementing components may comprise any shape, size, style, type, model, version, measurement, concentration, material, quantity, and/or the like as is known in the art for such eyeglasses holders on pants and implementing components, consistent with the intended operation of an eyeglasses holder on pants.

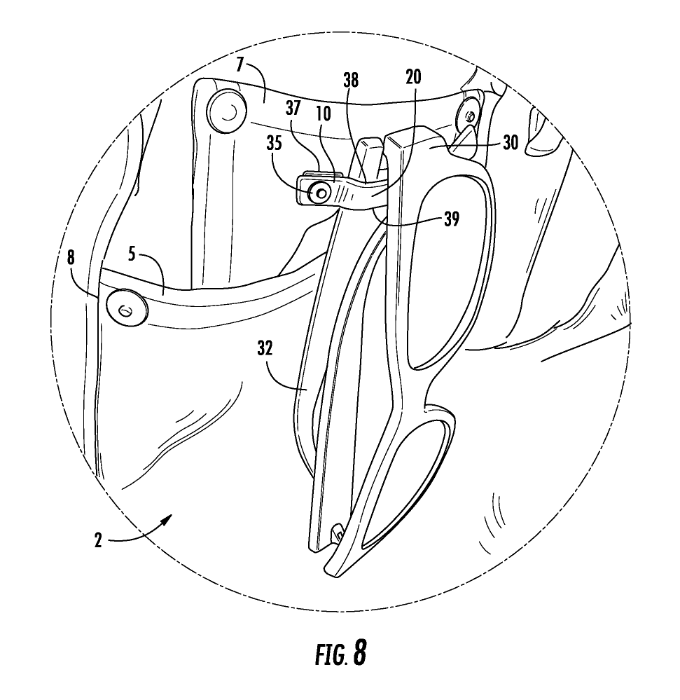

Contemplated as part of this disclosure is an eyeglasses holder for pants, or pants having an eyeglasses holder. The eyeglasses holder is attached to the pants and configured to hold various types of eyeglasses, such as, but not limited to, glasses, sunglasses, and the like. FIG. 8 depicts a non-limiting embodiment of an eyeglasses holder holding a pair of sunglasses 30. In one more embodiments, the eyeglasses holder comprises a strip of material 10 coupled to the pants 2 at opposing ends 11, 12 of the strip of material 10, while leaving a portion of the strip of material 10 as an uncoupled portion 20 between the two opposing ends 11, 12 to form a gap 15 between the strip of material 10 and the pants 2. The strip of material 10 of the eyeglasses holder may be added as an after-market addition to the pants 2 by using mastic or other adhesive, or by using rivets or snaps, hook and loop fasteners, or other attachment mechanism. As contemplated herein, “strip” is configured to include any of a variety of shapes and configurations that allow opposing ends 11, 12 or sides of a shape to be coupled to pants 2, while leaving a portion of the shape as an uncoupled portion 20 between the two opposing ends 11, 12 or sides. “Ends” of the strip may be anywhere between the midpoint and the physical end of the strip of material 10.

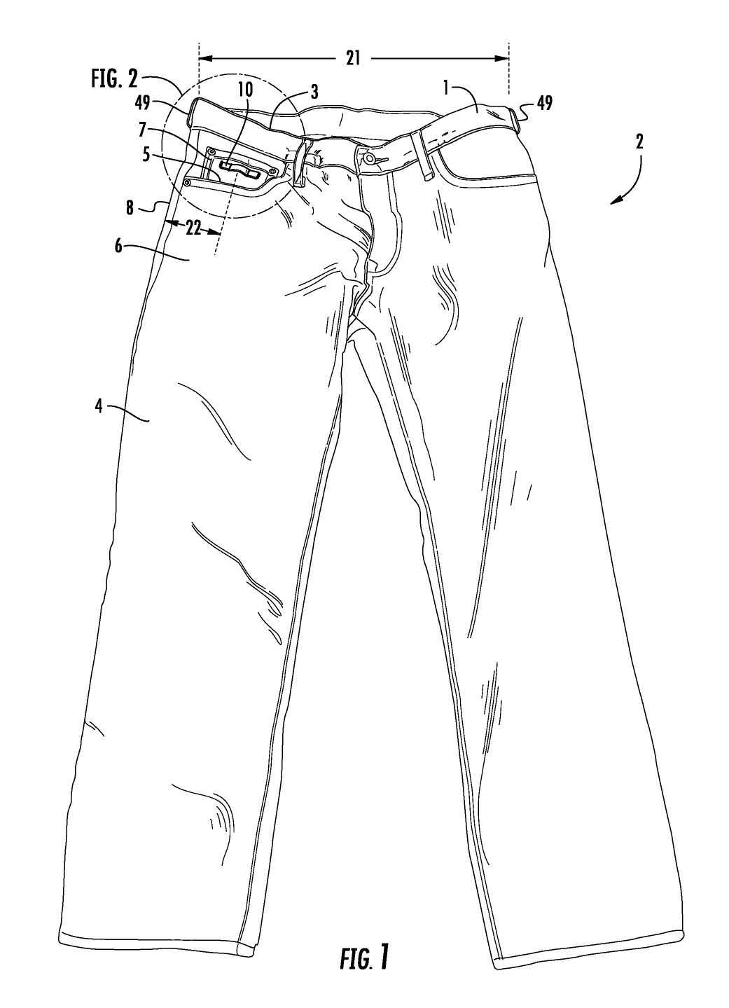

The eyeglasses holder may be utilized with any of a variety of pants or shorts, including but not limited to jeans, slacks, and the like. FIG. 1 depicts a non-limiting embodiment of pants 2 to which a strip of material 10 may be coupled to form an eyeglasses holder. As is typical with most conventional pants, the pants 2 may include a front portion 4, a top portion that includes the upper half or ⅓ portion of the pants 2, a top edge 3, and a side seam 8. As used herein, a “side seam” means the physical side seam positioned on the side edge of the pants when the pants are laid flat on a flat surface, and also the side edge created on the pants when the pants are laid flat on a flat surface with the front of the pants facing forward, for example like as shown in FIG. 1. Side seam is intended to mean the position on the pants where the side seam is conventionally placed in the majority of ordinary pairs of pants, even if a formal seam is not actually placed at that location. One or more embodiments may further comprise a waistband 1, a scoop pocket edge 5, and a watch pocket 7. The pants 2 may further comprise a width 21 that is typically ½ of the circumference of the pants. In one or more embodiments, a width 21 of the pants 2 is measured on the front portion 4 of the pants between the two opposing side seams 8.

As contemplated in this disclosure, positioning of a horizontal strip of material 10 for an eyeglasses holder is advantageous at or near front pockets found on conventional pants. As used herein, “horizontal” is intended to refer to the general positioning of the elongated strip of material in relation to the ground when a wearer wears the pants. It is not intended to mean that the strip is perfectly horizontal, but rather that it is more horizontal than vertical in its orientation. Thus, a horizontal strip of material 10 may be angled between approximately 0 degrees and approximately 44 degrees relative to a horizontal plane. In such a configuration, the temple of eyeglasses positioned within a gap between the strip of material 10 and the pants 2 is positioned more vertical than horizontal. FIG. 8 depicts sunglasses removably coupled to a non-limiting embodiment of an eyeglasses holder formed by a horizontal strip of material 10 coupled to a front portion 4 at a top portion 6 of the pants 2. Sunglasses placed in the pocket of a wearer are likely to be crushed during normal use. If a strip is too high, the torso of the wearer may crush the eyeglasses or injure the wearer, when the wearer bends over. If the strip is too far to the side, the eyeglasses may get crushed or damaged when the wearer sits in a chair. If the strip is too low, the eyeglasses are likely to get crushed or otherwise damaged when the wear brushes up next any object or may even be too low for comfortable retrieval of the eyeglasses when the user reaches for them when standing up. Positioning of a strip of material 10 of an eyeglasses holder as contemplated herein also does not interfere with a seatbelt worn by the user in a vehicle.

As depicted in the non-limiting embodiment of FIG. 1, a horizontal strip of material 10 coupled to a front portion 2 and a top portion 6 of pants 2 may form an eyeglasses holder. The horizontal strip of an eyeglasses holder may comprise any of a variety of materials, such as but not limited to leather, cloth, nylon, rubber, silicon, cord, elastic cord, jean material, and the like. In one more embodiments, the strip of material 10 is positioned proximate a scoop pocket edge 5 on a front portion 4 of the pants 2. Even more particularly, a strip of material 10 of an eyeglasses holder may be coupled to pants 2 between the top edge 3 or waistband 1 of the pants 2 and a scoop pocket edge 5 on a front portion 4 of the pants 2. In particular embodiments, a strip of material 10 of an eyeglasses holder may be coupled to the pants 2 on an exterior of a watch pocket 7 positioned between a waistband 1 of the pants 2 and a scoop pocket edge 5 on a front portion 4 of the pants 2.

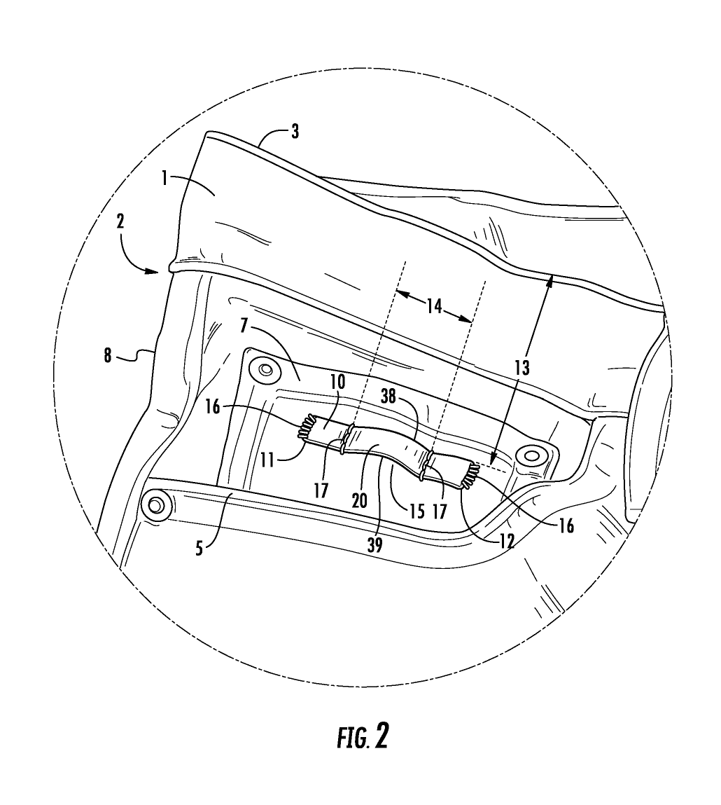

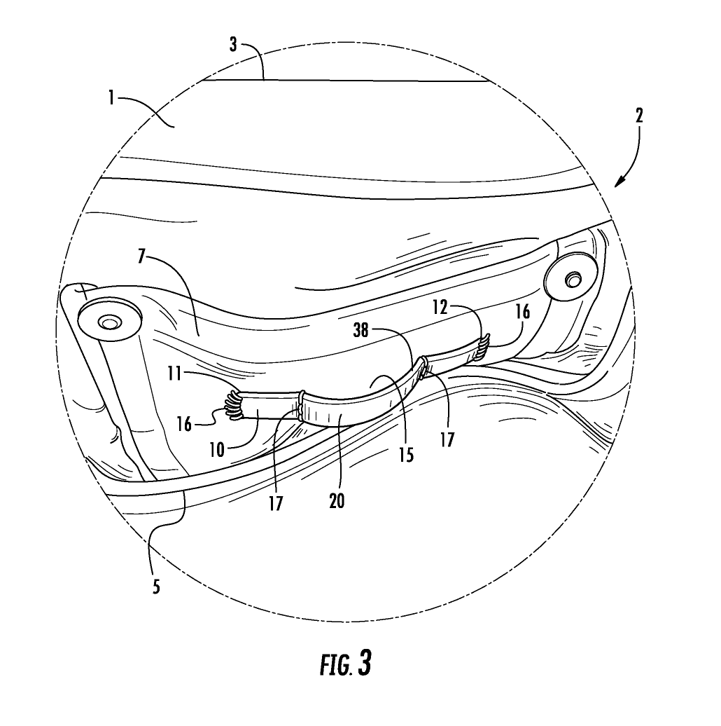

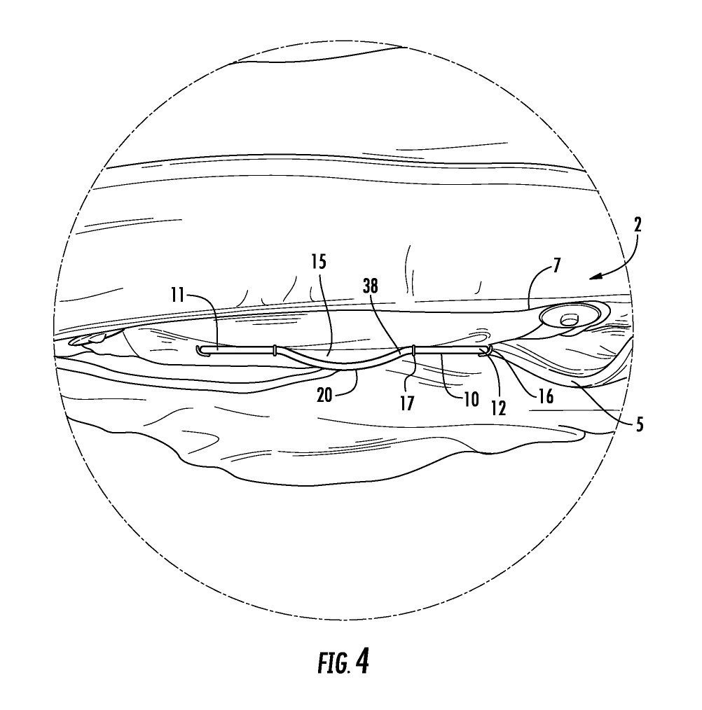

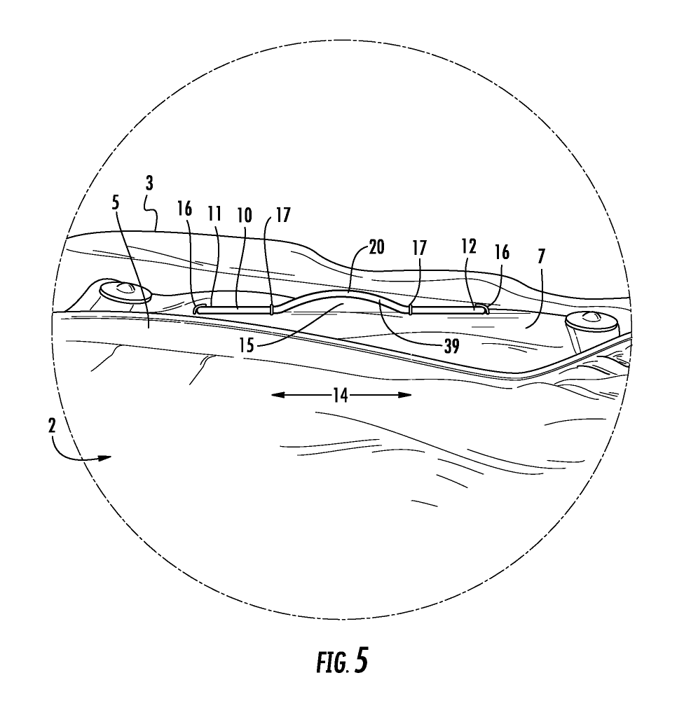

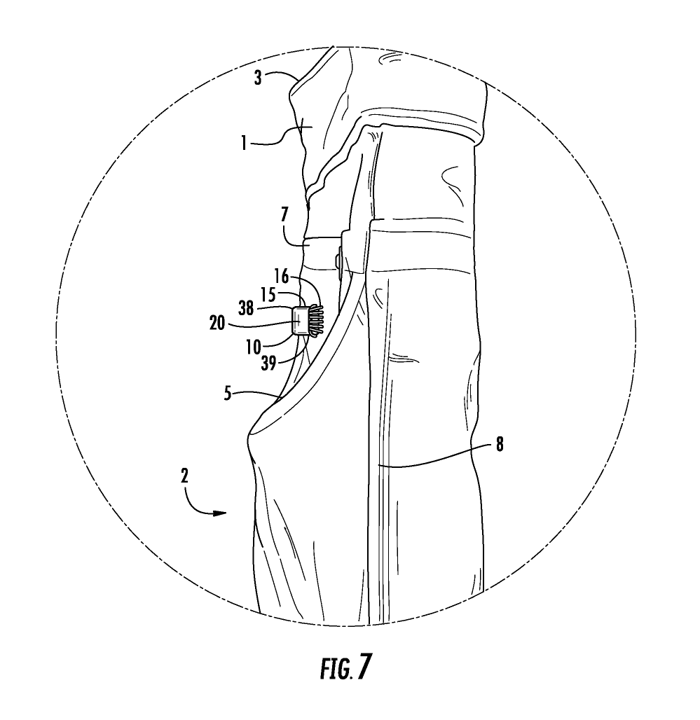

As shown in greater detail in the non-limiting embodiment depicted in FIG. 2, an eyeglasses holder may comprise a first end 11 of a horizontal strip of material 10 coupled to the front portion 4 of pants 2 and a second end 12 of a horizontal strip of material 10 coupled to the front portion of the pants 4. As used herein, a horizontal strip of material 10 means that the ends or portions of the strip of material 10 coupled to the pants are not aligned substantially perpendicular to the top edge 3 of the pants, as the top edge 3 of the pants 2 is typically horizontal when in use. Thus, while horizontal strip of material 10 shown in FIGS. 1-8 is substantially parallel with the top edge 3 of the pants 2, it is contemplated that a horizontal strip of material 10 may be angled or circular in shape so long as the two opposing ends of the horizontal strip of material are more horizontal than vertical in relation to the top edge 3 of the pants 2. Thus, in such a configuration, the temple of the eyeglasses positioned within a gap between the strip of material 10 and the pants 2 is positioned more vertical than horizontal, even when the horizontal strip of material is circular in shape.

In one or more embodiments, first or outer couplings 16 couples the ends 11, 12 of the strip of material 10 to the pants 2. The first couplings 16 may comprise any of a variety of couplings, such as but not limited to stitches, rivets, mastic, a backplate, adhesives, hook and loop fasteners (such as Velcro), and the like. Second or inner couplings may also couple the strip of material 10 to the pants 2 to form a gap 15, as shall be described in greater detail below. In the non-limiting embodiment depicted in FIG. 2, both the outer coupling 16 and the inner coupling 17 comprise threaded stitches. In the non-limiting embodiment depicted in FIG. 8, a horizontal strip of material 10 is coupled to the pants 2 with rivets 35 and adhesive 37. While only one end of the horizontal strip of material 10 is shown in FIG. 8, it is contemplated and understood to one of ordinary skill in the art that the opposing end obscured by the glasses 30 in FIG. 8 may include a similarly configured rivet 35 and adhesive 37 coupling the horizontal strip of material 10 to the pants 2. Moreover, while both a rivet 35 and adhesive 37 are depicted in FIG. 8, it is contemplated that in some embodiments only a rivet 35 or only adhesive 37 may couple each end 11, 12 of the horizontal strip of material 10 to the pants 2. In embodiments comprising rivets 35 and/or adhesive 37, both an inner and outer couplings may not be necessary, and instead may use only a single rivet 37 and/or adhesive 37 on each end 11, 12 of the horizontal strip of material 10 to couple the strip 20 to the pants and to define the boundaries of the width 14 of the gap 15. In some embodiments, one or more strips of material and a set of rivets and/or adhesive for each strip of material may be sold separate from a pair of pants as an aftermarket addition to the pants to be applied by the wearer at one of the location(s) described herein and in an orientation and manner described herein. The adhesive or the rivets may be pre-assembled with the material strip or be provided separate and assembled by the user.

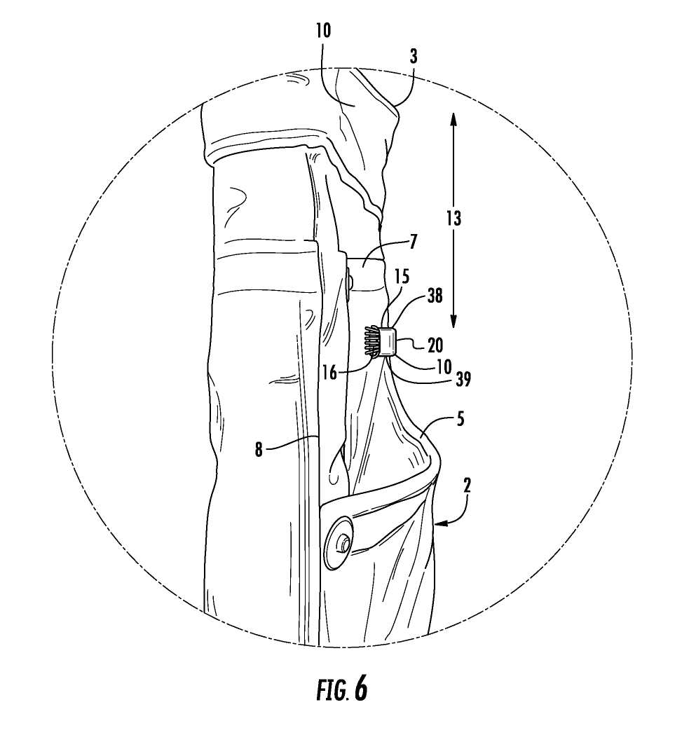

The dimensions of pants 2 vary greatly and optimal positioning of the strip of material 10 varies with differing waist size of pants 2. Those of ordinary skill in the art will readily understand how to position a strip of material 10 on a pair of pants 2 upon review of this disclosure. In some embodiments, a strip of material 10 of an eyeglasses holder is positioned at a distance 13 (shown in FIGS. 2 and 6) that is within approximately 6 inches from a top edge 3 of the pants 2. In more particular embodiments, a strip of material 10 of an eyeglasses holder is positioned within 5 inches from a top edge 3 of the pants 2. In still more particular embodiments, a strip of material 10 of an eyeglasses holder is positioned within 4 inches from a top edge 3 of the pants 2. In still more particular embodiments, a strip of material 10 of an eyeglasses holder is positioned within 3 inches from a top edge 3 of the pants 2. In any of these or other embodiments, the strip of material 10 may be positioned at least ½ inch from a top edge 3 of the pants 2. More particularly, the strip of material 10 may be positioned below the waistband 1 of the pants 2, whether the waistband 1 is a belted waistband or an elastic waistband. In other embodiments, the strip of material 10 may be positioned below the top edge 3 of the pants 10 but on the waistband.

In one or more embodiments, the strip of material 10 of an eyeglasses holder is positioned forward of the side seam 8 at a distance 22 that begins within 35% of the width 21 of the pants 2 as measured from the side seam of the pants. More particularly, the strip of material of an eyeglasses holder is positioned from the side seam 8 of the pants 2 at a distance 22 that is within 35% of the width 21 of the pants but not closer than 5% of the width 21 of the pants to the side seam 8. For example, if a front width 21 of pants is 17 inches from one side seam 8 to the opposite side seam 8, the strip of material 10 of an eyeglasses holder may be placed within 6 inches of a side seam 8, but not closer than 0.8 inches of the nearest side seam 8. In one or more embodiments, the strip of material 10 of an eyeglasses holder is positioned from the nearest side seam 8 at a distance 22 that is within 10-20% of the width 21 of the pants 2. Because the width 21 of the pants is one-half of the circumference of the pants 2, a 17 inch pants width 21 correlates to a 34 inch waist size. In other embodiments, the strip of material may be positioned on a rear portion of the pants 2 within 2″ of the side seam 8 or on the side seam 8 itself.

As contemplated herein, a portion of a strip of material 10 of an eyeglasses holder is left as an uncoupled portion 20 such that a gap 15 is formed between the strip of material 10 and the front portion 4 of the pants 2 and between opposing ends 11, 12 of the strip of material 10. In addition to the positioning of the strip of material 10 being an advantage, the size of the gap 15 between where the strip of material 10 is coupled to the pants 2 is advantageous because if the gap 15 is too large, the eyeglasses 30 will bounce around and are prone to fall from the strip of material 10. If the gap 15 is too small, some the sides 32 of some eyeglasses 30 will not fit within the gap 15 or it would not allow for back and forth and forward movement of the eyeglasses when the wearer walks or sits down.

A gap 15 may be formed between couplings that couple the strip of material 10 to the pants. For example a gap 15 may be formed between inner or second couplings 17 that couple the strip of material 10 to the pants 2. The second couplings 17 may be continuous with the nearest first coupling 16 or, as depicted in the non-limiting embodiments of FIGS. 1-8, separate from the first couplings 16. The second couplings 17 may comprise any of the couplings referenced with respect to the first couplings 16. In the non-limiting embodiment depicted in FIGS. 1-8, the second couplings 17 comprise stitching, with the uncoupled portion 20 being formed between the two second couplings 17. Alternatively, inner or second couplings 17 may not be necessary and the gap is formed only between first or outer couplings such as but not limited to the stitching, rivets, adhesives, and the like described above.

The gap 15 is a continuous channel that extends from a top edge 38 of the strip of material 10 to a bottom edge 39 of the strip of material 10 to allow a side 32 of the eyeglasses 30 to slide through the gap 15. According to some aspects, a gap 15 formed between the strip of material 10 and the front portion 4 for the pants 2 comprises a width 14 that is between approximately ½ inch to approximately 1 inch at a smallest width between two second or inner couplings 17 that border the uncoupled portion 20 and the gap 15. As used herein, approximately ½ inch and approximately 1 inch are referenced as approximate measurements because the sewing and attachment features are not exact in measurements. So in particular embodiments, the approximately ½ inch to approximately 1 inch measurements may be between exactly ½ inch and 1 inch, and in other embodiments there may be as much as a 25% margin of error above and below the measurements. In more particular embodiments, the gap 15 comprises a width 14 that is between approximately ⅝ inch to approximately ¾ inch at its narrowest point. In other embodiments, a gap 15 comprises a width 14 that is between approximately ¾ inch and ⅞ inch at its narrowest point.

Although particular embodiments in this disclosure show a strip on the right side watch pocket of pants, it should specifically be understood that a strip may be used on pants without a watch pocket or even without any pocket at all, and may be placed on either the left or right side of the pants, or both. The width of the strip is not as critical as the gap between the boundaries of the gap for use of the strip, but it is contemplated that the width of the strip will be less than 1 inch in most embodiments, and in particular embodiments less than ½ inch.

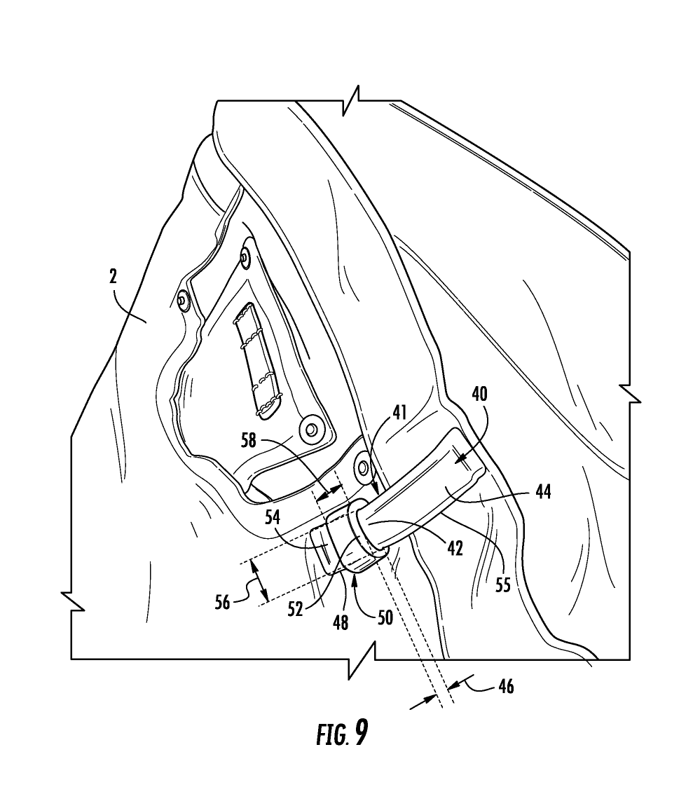

In another embodiment, an eyeglasses holder comprises a strip of material 50 coupled to one of side belt loop 49 or a front belt loop 40. Unless otherwise specified, a strip of material 50 may comprise any of the features described in relation to a strip of material 40 described elsewhere in this document. FIG. 9 depicts a non-limiting embodiment of an eyeglasses holder on pants comprising a strip of material 50 coupled to a front belt loop 40 of pants 2. Although FIG. 9 depicts a strip of material 50 coupled to a front belt loop 40, it is also contemplated that a strip of material 50 may be coupled to a side belt loop 49 (shown in FIG. 1) in any manner described in relation to a front belt loop 50 without departing from the scope of this disclosure. According to some aspects, a strip of material 50 comprises a height 58 greater than approximately ⅛″. More particularly, a strip of material 50 may comprise a height 58 greater than approximately ½″. In other embodiments, a strip of material 50 may comprise a height 58 of between approximately ⅛″ and approximately ¾″. In still other embodiments, a strip of material 50 may comprise a height of between approximately ⅛″ and approximately ½″.

A strip of material 50 may be coupled to a belt loop 40 in a variety of configurations. In one or more embodiments, such as the non-limiting embodiment shown in FIG. 9, a strip of material 50 is coupled to the belt loop 40 such that the strip of material 50 encircles the belt loop 40. In other embodiments, a strip of material 50 may be coupled to side edges 55 or front portion 44 of the belt loop 40 without encircling the belt loop 50. In these and other contemplated embodiments, the strip of material 50 is substantially horizontal (as defined elsewhere in this document) in positioning. That is, a gap 42 formed between the strip of material 50 and the front portion 44 of the belt loop 40 is positioned such that a temple of a eyeglasses positioned within the gap 42 is substantially vertical (or more vertical than horizontal). In one or more embodiments, a strip of material 50 is slidably coupled to a belt loop 40. When slidably coupled to a belt loop 40, a strip of material 50 may only encircle the belt loop 40 and not be directly coupled to the belt loop 40. In other embodiments, a strip of material 50 is positionally coupled to a belt loop 40 with one of adhesives 37 or stitching. Adhesives 37 or stitching may couple a portion of the strip of material 50 directly to a rear portion 41 of the belt loop 40. In other embodiments, adhesives 37 or stitching may couple a portion of the strip of material 50 directly to a front portion 44 of the belt loop 40. According to some aspects, a strip of material 50 is coupled to a lower half 48 of the belt loop 40.

As noted above, a strip of material 50 is coupled to belt loop 40 such that a gap 42 is formed between a front portion 44 of a belt loop 40 and the strip of material 50. The gap 42 extends continuously from a top edge 52 of the strip of material 50 to a bottom edge 54 of the strip of material 50. In particular embodiments, the gap 42 also extends continuously between two opposing side edges 55 of the belt loop 40. A gap 42 formed between the strip of material 50 and the front portion 44 of the belt loop 40 is positioned such that a temple of a eyeglasses positioned within the gap 42 is substantially vertical (or more vertical than horizontal). A width 56 of a gap 42 may be substantially equal to a width of the belt loop 40 or may comprise a width 56 that is different than a width of a belt loop 40. In one or more embodiments, a gap comprises a width 56 between approximately ¼″ and approximately ¾″. In more particular embodiments, a gap 42 may comprise a width 56 of approximately ½″. According to some aspects, a gap 42 comprises a height 46 of approximately ⅛″.

Also contemplated as part of this disclosure is a method of forming an eyeglasses holder on pants 2. According to some aspects, a method comprises preparing a strip of material for coupling to the pants 2. Preparing a strip of material for coupling to the pants 2 may comprise cutting the strip of material in a desired shape and/or treating the strip of material. A method may further comprise coupling the strip of material to the pants 2. According to some aspects, coupling a strip of material to the pants 2 comprises coupling the strip of material 50 to at least one of a front belt loop 40 and a side belt loop 49 of the pants 2. A method may further comprise forming a gap 42 between an unattached portion of the strip of material 50 and the pants 2. According to some aspects, forming a gap between the unattached portion of the strip of material and the pants 2 comprises forming the gap 42 between the unattached portion of the strip of material 50 and a front portion 44 of either the front belt loop 40 or the side belt loop 49 of the pants 2. In one or more embodiments, coupling the strip of material 50 to either the front belt loop 40 or the side belt loop 49 comprises slidably coupling the strip of material 50 to either the front belt loop 40 or the side belt loop 49. On other embodiments, coupling the strip of material 50 to either the front belt loop 40 or the side belt loop 49 comprises positionally coupling the strip of material to one of the front belt loop and the side belt loop with one of stitching and adhesive.

In another embodiment, coupling the strip of material to the pants comprises coupling two opposing ends of the strip of material 10 within 6″ of a top edge 3 of the pants such that the unattached portion of the strip of material 10 is between the two opposing ends coupled to the top portion of the pants 2. A method may further comprise forming a gap between an unattached portion of the strip of material 10 and the pants 2, the gap extending continuously from a top edge of the strip of material 10 to a bottom edge of the strip of material 10. Forming the gap between the unattached portion of the strip of material 10 and the pants 2 may comprise forming a gap between the unattached portion of the strip of material 10 and the pants 2 that is between approximately ½″ and approximately 1″ in width. Coupling the two opposing ends of the strip of material 10 within 6″ of the top edge 3 of the pants may comprise coupling the strip of material 10 between the top edge 3 of the pants 2 and a scoop pocket edge 5 of the pants 2.

It will be understood that implementations are not limited to the specific components disclosed herein, as virtually any components consistent with the intended operation of a method and/or system implementation for an eyeglasses holder on pants may be utilized. Accordingly, for example, although particular strips may be disclosed, such components may comprise any shape, size, style, type, model, version, class, grade, measurement, concentration, material, weight, quantity, and/or the like consistent with the intended operation of a method and/or system implementation for an eyeglasses holder on pants may be used.

1. An eyeglasses holder on pants, comprising:
a strip of material coupled to and encircling a belt loop of the pants, the strip of material being positionally affixed to a portion of the belt loop with stitching and configured to receive an earpiece of eyeglasses therethrough and support the eyeglasses from the strip of material positionally affixed to the belt loop; and
a gap formed between the strip of material and a front portion of the belt loop, the gap extending continuously from a top edge of the strip of material to a bottom edge of the strip of material and comprising a width of between approximately ¼″ and approximately ¾″.

2. (canceled)

3. The eyeglasses holder on pants of claim 1, wherein the strip of material is positionally affixed to a lower half of the belt loop.

4. The eyeglasses holder on pants of claim 3, wherein the portion of the belt loop to which the strip of material is positionally affixed is a rear portion of the belt loop.

5. (canceled)

6. The eyeglasses holder on pants of claim 1, wherein the belt loop comprises one of a front belt loop and a side belt loop on the pants.

7. The eyeglasses holder on pants of claim 1, wherein a height of the gap is approximately ⅛″.

8. An eyeglasses holder on pants, comprising:
a strip of material positionally affixed to a belt loop of the pants with stitching, wherein the strip of material comprises a top edge and a bottom edge opposite the top edge, and wherein the belt loop comprises a front portion, a rear portion opposite the front portion and facing the pants, and two opposing side edges;
a gap formed between the strip of material and the front portion of the belt loop, the gap extending continuously from the top edge of the strip of material to the bottom edge of the strip of material and continuously between the two opposing side edges of the belt loop, the gap configured to receive an earpiece of eyeglasses therethrough to support the eyeglasses from the strip of material positionally affixed to the belt loop.

9. The eyeglasses holder on pants of claim 8, wherein the strip of material encircles the belt loop.

10. The eyeglasses holder on pants of claim 9, wherein the strip of material is slidably coupled to the belt loop.

11. The eyeglasses holder on pants of claim 9, wherein the strip of material is positionally affixed to a lower half of the belt loop.

12. The eyeglasses holder on pants of claim 9, wherein the strip of material is positionally affixed to a rear portion of the belt loop.

13. The eyeglasses holder on pants of claim 9, wherein the belt loop comprises one of a front belt loop and a side belt loop on the pants.

14. A method of forming an eyeglasses holder on pants, comprising:
providing a strip of material for coupling to the pants;
coupling the strip of material to the pants;
forming a gap between an unattached portion of the strip of material and the pants, the gap extending continuously from a top edge of the strip of material to a bottom edge of the strip of material; and
placing an earpiece of a pair of eyeglasses through the gap so that the earpiece extends through the gap continuously from the top edge of the strip of material to the bottom edge of the strip of material and extends from the bottom edge of the strip of material.

15. The method of claim 14, wherein coupling the strip of material to the pants comprises coupling the strip of material to one of a front belt loop and a side belt loop of the pants, and wherein forming the gap between the unattached portion of the strip of material and the pants comprises forming the gap between the unattached portion of the strip of material and a front portion of the one of the front belt loop and the side belt loop of the pants.

16. The method of claim 15, wherein coupling the strip of material to one of the front belt loop and the side belt loop comprises slidably coupling the strip of material to one of the front belt loop and the side belt loop.

17. The method of claim 15, wherein coupling the strip of material to one of the front belt loop and the side belt loop comprises positionally coupling the strip of material to one of the front belt loop and the side belt loop with one of stitching and adhesive.

18. The method of claim 14, wherein coupling the strip of material to the pants comprises coupling two opposing ends of the strip of material within 6″ of a top edge of the pants such that the unattached portion of the strip of material is between the two opposing ends coupled to the top portion of the pants.

19. The method of claim 18, wherein forming the gap between the unattached portion of the strip of material and the pants comprises forming a gap between the unattached portion of the strip of material and the pants that is between approximately ½″ and approximately 1″ in width.

20. The method of claim 19, wherein coupling the two opposing ends of the strip of material within 6″ of the top edge of the pants comprises coupling the strip of material between the top edge of the pants and a scoop pocket edge of the pants.

21. The method of claim 14, wherein coupling the strip of material to the pants comprises coupling the strip of material to the front of the pants.

22. The method of claim 14, wherein coupling the strip of material to the pants comprises coupling the strip of material to the pants with stitching.
